(19) United States
(12) Patent Application Publication
(10) Pub. No.: US 2002/0099653 A1
(43) Pub. Date: Jul. 25, 2002

(54) E-commerce application service provider micro-billing method and system

(76) Inventors: Celso Candido De Souza, Curitiba (BR); Francisco Rodolfo Eduardo Pesserl, Curitiba (BR); Stephen Douglas Merry, Moorpark, CA (US)

Correspondence Address: RABIN & CHAMPAGNE, PC, 1101 14TH STREET, NW, SUITE 500, WASHINGTON, DC, 20005, US

(21) Appl. No.: 09/730,383

(22) Filed: Dec. 6, 2000

Related U.S. Application Data
(60) Provisional application No. 60/169,329, filed on Dec. 6, 1999.

(51) Int. Cl. G06F 17/60

(52) U.S. Cl. 705/40

(57) ABSTRACT

A method for micro-payments in an E-commerce system. A record of usage of the E-commerce system is created for each system user based on transactional documents transmitted in the E-commerce system. The record of usage is stored on a computer readable medium and retrieved in a periodic manner. An invoice is created for each user of the E-commerce system based on their system usage. System usage can comprise sending transactional documents, such as requests for quotes, sales proposals, signed contracts, and purchase orders. System usage can further comprise the amount of memory consumed by a server side user's database.

### CROSS REFERENCE

This application claims the benefit under 35 U.S.C. §119(e) of U.S. Provisional Patent Application No. 60/169,329, filed on Dec. 6, 1999. This application is also related to application Ser. No. 09/652,568, filed on Aug. 31, 2000, entitled “E-Commerce Market-Place Using an Extranet Platform”. Both of the above applications are herein incorporated by reference, but are not admitted to be prior art.

### TECHNICAL FIELD

This invention relates generally to e-commerce and more specifically to a method for billing e-commerce platform users.

### BACKGROUND OF THE INVENTION

Electronic Commerce (E-commerce), is likely to become the predominant means for performing business over the coming decades. E-commerce consists of the ability to transact business over an electronic network, such as the Internet. Typical transactions can include the buying and selling of goods, although it is possible in theory to perform any commerce related function in an electronic forum.

One of the problems associated with E-commerce is the method and system for billing the individuals or enterprises that utilize the system. At present, some E-commerce platforms bill users based on the number of transactions available in the system and presents them with an electronic or written invoice. This billing method does not accurately reflect the amount of usage of the system. Another typical method for billing is based on the number of users at a site, such that the fee is a user license fee that may be charged on a monthly or an annual basis.

Extranet-based or Application Service Provider (ASP)-based E-commerce platforms, in which the user (typically a small or medium sized business enterprise) does not have a centralized E-commerce server, present additional billing difficulties. For these users, information is distributed in the system, and is not located at one single location.

For the foregoing reasons, there is a need for a billing method and system that can accurately collect user usage information and bill the user according to their actual usage of the system.

### SUMMARY OF THE INVENTION

To achieve these and other objectives, and in view of its purposes, the present invention provides a method and system for micro-payments in an extranet-based or ASP-based E-commerce platform. Micro-payment is defined as, payment on a per transaction basis or microscopic level, rather than or a generic licensing basis or macroscopic level.

In one embodiment of the present invention, an acent (i.e., software code) is installed at the server side of a client-server architecture. This agent creates and stores document flow records, which include specific information about particular documents transmitted by the platform user. The particular documents for which information is created and stored are preferably documents used in commercial transactions for which platform users are billed (i.e., remitted documents), such as purchase orders, sales and purchasing contracts, requests for quotes, offers of sale, and the like. Optionally, the agent can also store specific information about the size of the server side user's database. In another option, the agent can also be used to collect and store a summary of information on transactions over a specific period of time (i.e., one month). The summary can include a variety of information, such as the month and year of the transaction information, name of the base where the billing is being performed, present size of the user's database, average size of the user's database, total number of billable documents sent during the last month, number and type of documents to be accounted for during the current billing period, monthly fee, disk space fee value, transaction fee value, and total value of the monthly bill. The billing information can also be stored and used on the server side by another agent for statistical and analysis procedures.

In the present invention, billing may be performed by the application service provider or a third party. A third party could be a bank, a telephone company, or other entity that is capable of performing the billing function. Billing can be performed by sending an invoice to the consumer (i.e., platform user), direct electronic billing, or billing through a third party.

One advantage of the present invention is that it allows the ASP to micro-bill for each subscriber's usage. Payments can be dependent upon the number of particular billable transactions performed, the amount of computer storage utilized, or a combination of these usages. A variety of pricing schemes can be utilized.

Another advantage of the present invention is that a third party can become the billing party. Therefore, the third party can see a larger percentage of the profit for operation of the system, although the third party may not be the ASP provider.

These and other features and objects of the present invention will be more fully understood from the following detailed description of the preferred embodiments which should be read in light of the accompanying drawings. It should be understood that both the foregoing general description and the following detailed description are exemplary, but are not restrictive, of the invention.

### BRIEF DESCRIPTION OF THE DRAWINGS

The accompanying drawings, which are incorporated in and form a part of the specification, illustrate the embodiments of the present invention. Together with the detailed description, the accompanying drawings serve to explain the principles of the invention.

FIG. 1 illustrates a prior art method of performing e-commerce using the Internet with an enterprise system;

FIG. 2 illustrates a prior art method of performing e-commerce using Internet-based hosting;

FIG. 3 illustrates an Extranet-based E-commerce Platform (EBEP);

FIG. 4 illustrates an architecture for an EBEP according to one embodiment of the present invention;

FIG. 5 illustrates an EBEP implementation according to one embodiment of the present invention;

FIG. 6 illustrates a use-case diagram for the E—commerce application service provider micro-billing method and system;

FIG. 7 illustrates an architecture for application of the E-commerce application service provider micro-billing method and system;

FIGS. 8A and 8B illustrate examples of a document flow record and a monthly report which are stored on the server side;

FIG. 9 illustrates a summary report which represents the user's extract; and

FIG. 10 illustrates an example of a user's invoice.

### DETAILED DESCRIPTION OF THE PREFERRED EMBODIMENT

In describing a preferred embodiment of the invention illustrated in the drawing, specific terminology will be used for the sake of clarity. However, the invention is not intended to be limited to the specific terms so selected. Rather, it is to be understood that each specific term includes all technical equivalents which operate in a similar manner to accomplish a similar purpose.

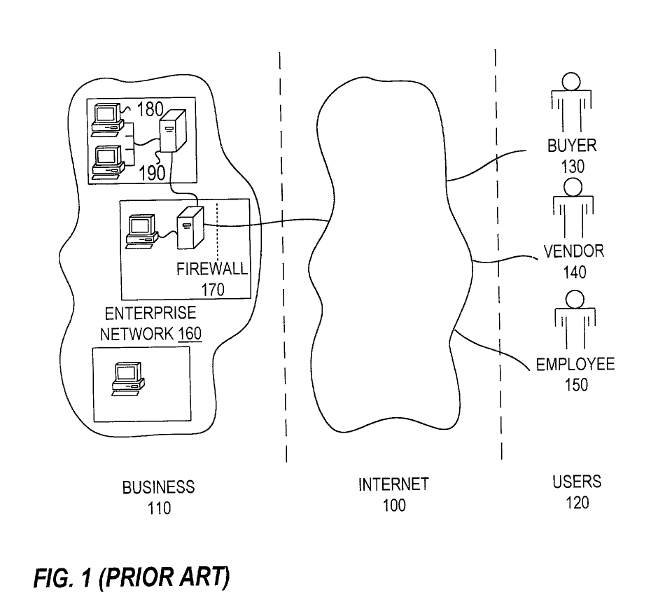

With reference to the drawing in general, and FIGS. 1 through 10 in particular, the method and system of the present invention is disclosed.

One approach to E-commerce is the enterprise system. FIG. 1 illustrates a typical enterprise-based E-commerce system. A business entity (110) provides limited access to an existing or custom-created enterprise network (160) through a firewall (170). Internal users such as employees (150), and external users, such as customer purchasing agents (buyers) (130) and vendors (140) access the enterprise network (160) through the Internet (100), with access limited by the firewall (170). The firewall (170) comprises software (i.e., code), designed to limit access to a database depending upon passwords and pre-coded access privileges.

This typical enterprise-based, E-commerce system suffers from several deficiencies. First, an enterprise network (160) requires a substantial capital investment for custom software. Second, the enterprise network (160) may have difficulty communicating with potential customers or vendors who utilize protocols that are incompatible with the enterprise network's proprietary language. Third, the enterprise network (160) requires a potential consumer to separately connect to each potential supplier. If a potential consumer needs to search for a suitable item and wishes to perform a price comparison, prior to making an order, multiple rounds of inquiries, each necessitating multiple connections, would be required. Finally, many facets of a normal business relationship must be conducted off-line, including but not limited to negotiating, soliciting bids, and executing a requirements contract.

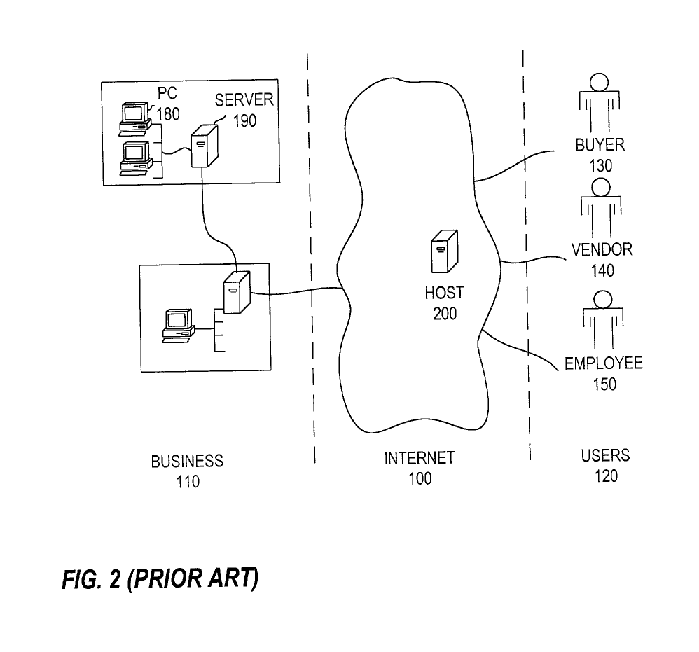

An alternative to the enterprise-based E-commerce system is an Internet-hosted system for E-commerce, as illustrated in FIG. 2. In a typical Internet-hosted system for E-commerce, a business entity (110) places information such as a catalog on a host server (200) in the Internet (100) where it is accessible to the public. Potential buyers (130) of the business, entity's product or service can typically search a catalog on the host server and, in some cases, place orders. Vendors (140) and employees (150) of the business entity (110) can access the host server (200) for information about the business entity (110).

This typical Internet-hosted system for E-commerce suffers from several deficiencies. First, business content on the host server (200) must be manually input. Second, updates to the business content on the host server (200) are generally controlled by the hosting entity and not by the business entity (110) whose content is being hosted. Third, while some automation of the business entity's (110) sales transactions is typical, automation of purchase transactions is not available. Finally, many facets of a normal business relationship must be conducted off-line, including but not limited to negotiating, soliciting bids, and executing a requirements contract.

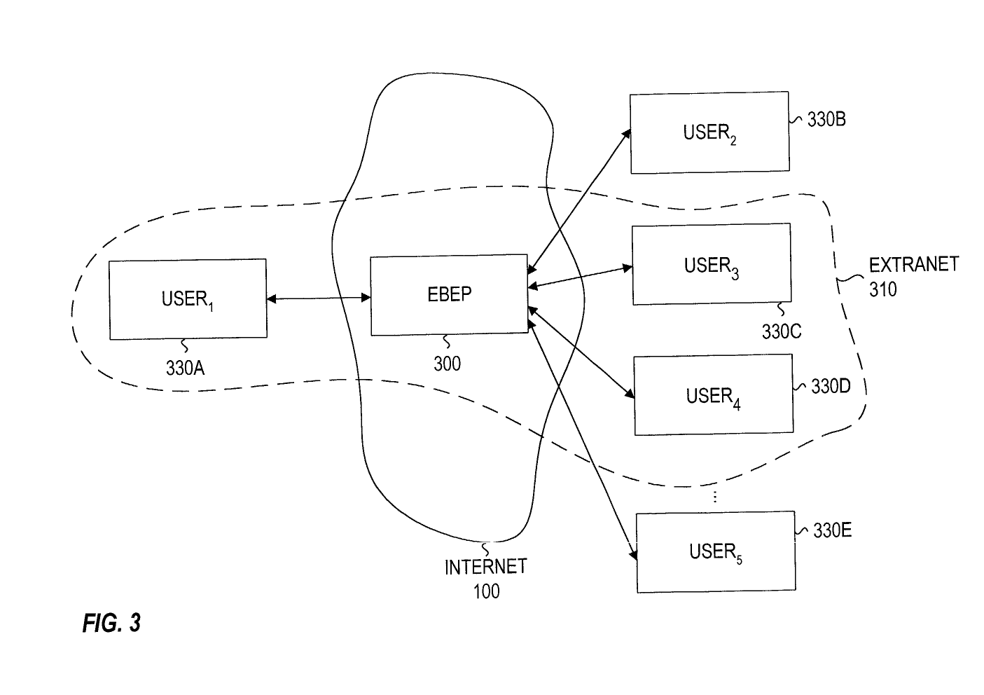

FIG. 3 illustrates an extranet-based E-commerce platform (EBEP), wherein each EBEP user creates a custom extranet. For example, a first EBEP user (330A) of the extranet-based e-commerce platform (EBEP) (300) creates a custom extranet (310) by selecting other EBEP users (330C, 330D) from the community of EBEP users (330B, 330C, 330D, 330E). The EBEP users (330C, 330D) in the first EPEP user's (330A) custom extranet (310) could be vendors to the first EBEP user (330A), customers of the first EBEP user (330A), or preferably both. When business functions are performed, only the EBEP users (330C, 330D) in the first EBEP user's (330A) custom extranet (310) are involved.

The custom extranet (310) provides several advantages over other e-commerce platforms. By limiting product/service searches to EBEP users (330 B-E) that the first EBEP user (330A) wants to transact commerce with (e.g. strategic partners, preferred suppliers, and the like), electronic traffic is reduced, making the EBEP (300) more efficient, and eliminating wasted time sorting through unsolicited and unwanted offers. The custom extranet (310) can also reduce rogue buying with the first EBEP user's (330A) organization. Rogue buying is defined as the purchase of a product or service from a vendor other than the vendor with whom the first EBEP user (330A) has a contract for that product or service. Reducing rogue buying can provide substantial savings.

Another advantage of the custom extranet (310) is that it can help to maintain confidentiality. Only EBEP users (330C, 330D) selected for the first EBEP user's (330A) custom extranet (310) have access to information identified as confidential by the first EBEP user (330A). This can be particularly important when financial information is provided in the custom extranet (310).

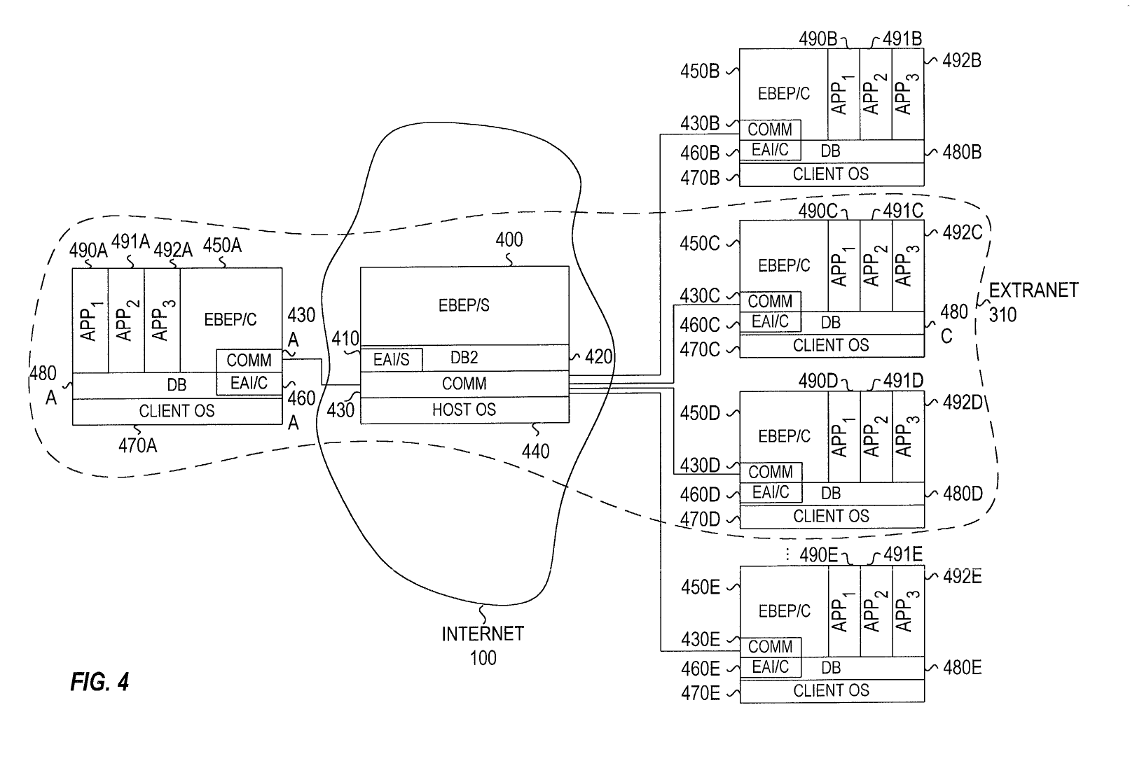

FIG. 4 illustrates architecture of an EBEP, according to one embodiment of the present invention. The first EBEP user's software comprises a client-side operating system (470A), a first database (480A), user applications (490A, 491A, 492A), extranet-based e-commerce platform software (450A), client-side Enterprise Application Integration (EAI) software (460A) and communications layer software (430A). In this embodiment, the first EBEP user's software communicates through the communication layer (430A) to a host server on the Internet (100). The host server software comprises a host operating system (440), a database software (420), server-side extranet-based e-commerce platform software (400), server-side EAI software (410), and communications layer software (430).

The host server is also connected to other EBEP users through the communications layer software (430). The other EBEP users' software comprises client-side operating systems (470B, 470C, 470D, 470E), databases (480B, 480C, 480D, 480E), user applications (490B, 491B, 492B; 490C, 491C, 492C; 490D, 491D, 492D; 490E, 491E, 492E), extranet-based e-commerce platform software (450B, 450C, 450D, 450E), client-side EAI software (460B, 460C, 460D, 460E) and communications layer software (430B, 430C, 430D, 430E).

It should be understood that the EBEP users will all use the same client side EBEP software (450), client-side EAI software (460), and communications layer software (430). The EBEP users may have the same or different client-side operating software (470), database software (480), and applications software (490, 491, 492). It should be further understood that although the foregoing description is based on a client-server architecture over the public Internet (100), other architectures are possible within the scope of the present invention, as well as, other types of networks.

Client-side EBEP software (450) comprises data entry software. The client-side EBEP software (450) may further include data manipulation for that EBEP user's data. The interactive functions of an EBEP, according to the present invention, are preferably programmed into the server-side extranet-based e-commerce platform software (400), which is loaded on the server(s) for the extranet-based e-commerce platform. The server(s) preferably uses an active server page (ASP) format.

The architecture of FIG. 4 provides a complex relationship between the full databases of multiple parties or enterprises. Instead of merely providing access to the data of one enterprise by other enterprises or individuals, the data from one enterprise can interact with data from another enterprise through EAI and EBEP functionality.

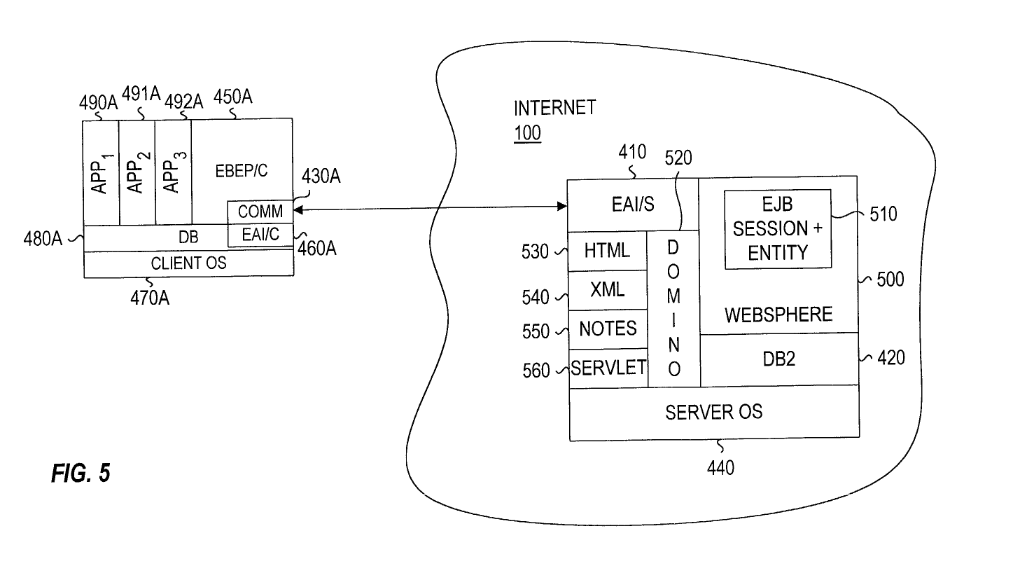

FIG. 5 illustrates an implementation of the EBEP according to one embodiment of the present invention. A first EBEP user connects to a server on the Internet (100). The client side of the connection is essentially the same architecture as shown in FIG. 4. On the server side of the connection, an enterprise java beans architecture (EJB) is used. EJB is a product of Sun Microsystems of Palo Alta, Calif. A high-performance open-architecture transaction manager, in this embodiment the Websphere application (500) from International Business Machine, Inc. (IBM) of Armonk, N.Y., may be installed on the server to monitor and manage transactions between enterprises or the EBEP. Although this embodiment uses Websphere as the preferred example, it will be obvious to those of ordinary skill in the art that the invention is scalable so that similar high-performance open-architecture transaction manager applications may be used. In this embodiment, the Websphere application (500) establishes an EJB session/entity (510) associated with the entity (i.e., enterprise) who established it. EJB (510) uses a piece of application code to assemble a working application to perform EBEP functionalities. In an alternate embodiment, NOTES and DOMINO applications may provide basic transaction management for users with smaller traffic requirements.

In a preferred embodiment, the server side EAI software (410) is incorporated using DOMINO (520) by Lotus Development of Cambridge, Mass. DOMINO (520) allows the EJB application to read data in a variety of languages, including hyper text markup language (HMTL) (530), extensible markup language (XMI,) (540), NOTES (550) by International Business Machines (IBM) and Lotus Development, and SERVLET (560) by Sun Microsystems.

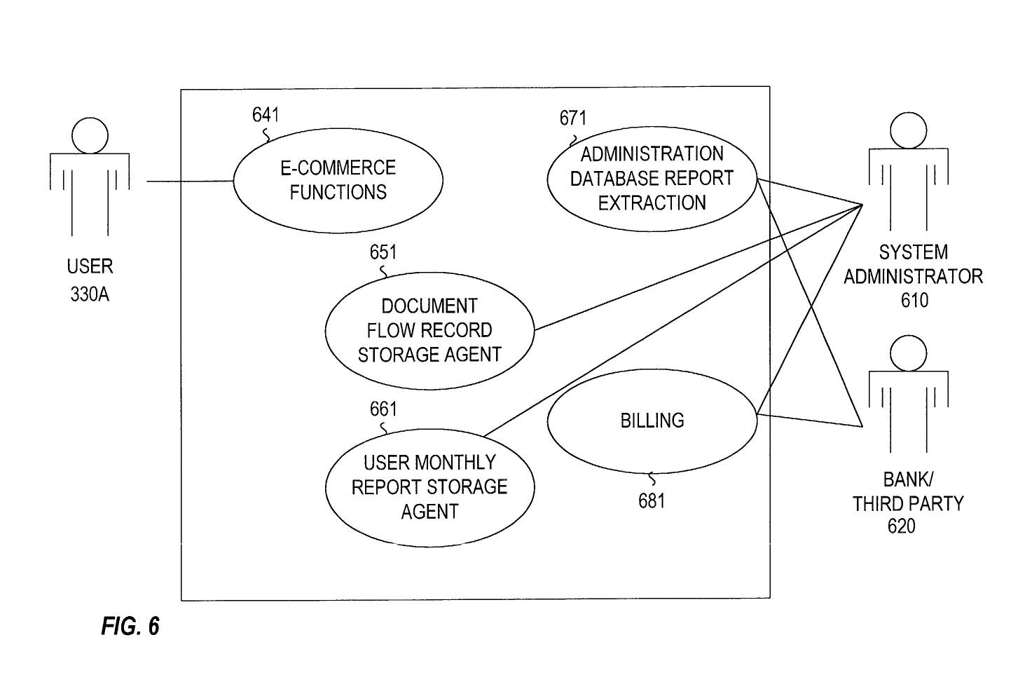

FIG. 6 illustrates a use-case diagram for an E-commerce application service provider micro-billing system in which a user (330A), system administrator (610) and a bank/third party (620) use the system. The user (330A) has access to all of the E-commerce functions that allow for sending requests for quotes and other transactional documents. The system also comprises a document flow record creation and storage agent (651) which writes key information regarding each document in a defined set of transactional documents, producing a machine-readable document flow record (not shown), as will be described in greater detail hereafter. The document flow record creation and storage agent (651) collects this information from the actual E-commerce transactions (641), preferably on a daily basis. In a preferred embodiment, the document flow record creation and storage agent (651) runs on the user's database on the server side of the E-commerce system (server side user's database).

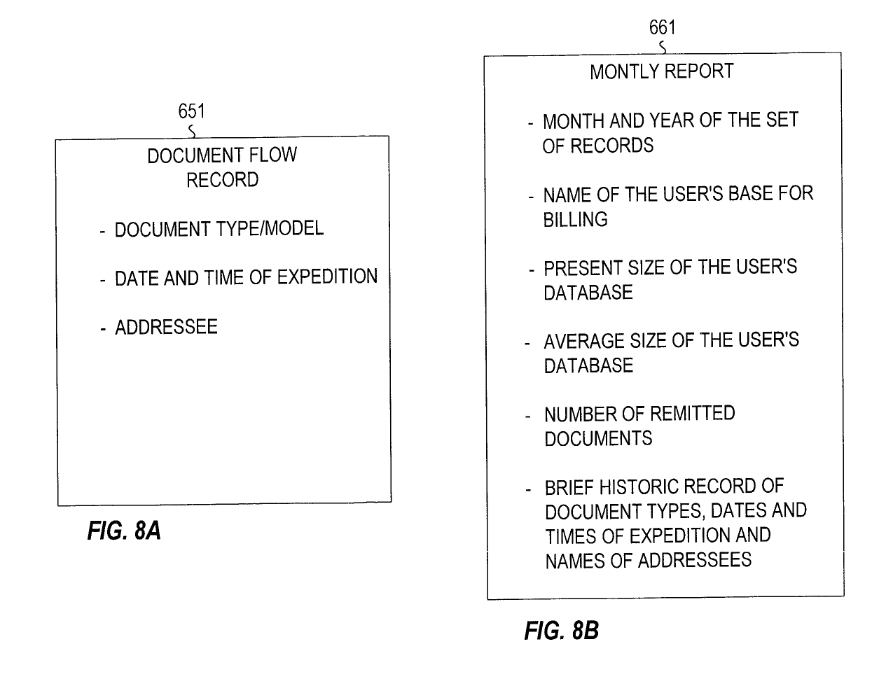

The system further comprises a periodic report agent (661) which generates and stores a detailed periodic report (not shown) such as the one shown in FIG. 8B, as will be described in greater detail hereafter. In a preferred embodiment, the periodic report is stored in the form of a database on the server side (server side user's database) of the system. The periodic report agent (661) preferably collects transactional information for a specific user on a monthly basis. This transaction information is collected from the document flow record creation and storage agent (651). In a preferred embodiment, the transaction information is stored at the server side of the E-commerce system.

An administration database report extraction agent (671) can be provided at the server side of the system. The administration database report extraction agent (671) is used to collect information from the server side user's database and more particularly from the periodic report database (661). This information may be used to extract relevant statistical parameters regarding system usage for use by the system administrator (610).

A billing module (681) is used to create a user invoice. In a preferred embodiment, the billing module (681) is resident on the server side of the system and creates an invoice, which is transmitted either electronically or by other means to the user (330A). Optionally, an invoice can be integrated into a third party (620) billing. In this case, the user (330A) is charged for its E-commerce services as part of its telephone, banking, or other telecommunications or commercial service bill.

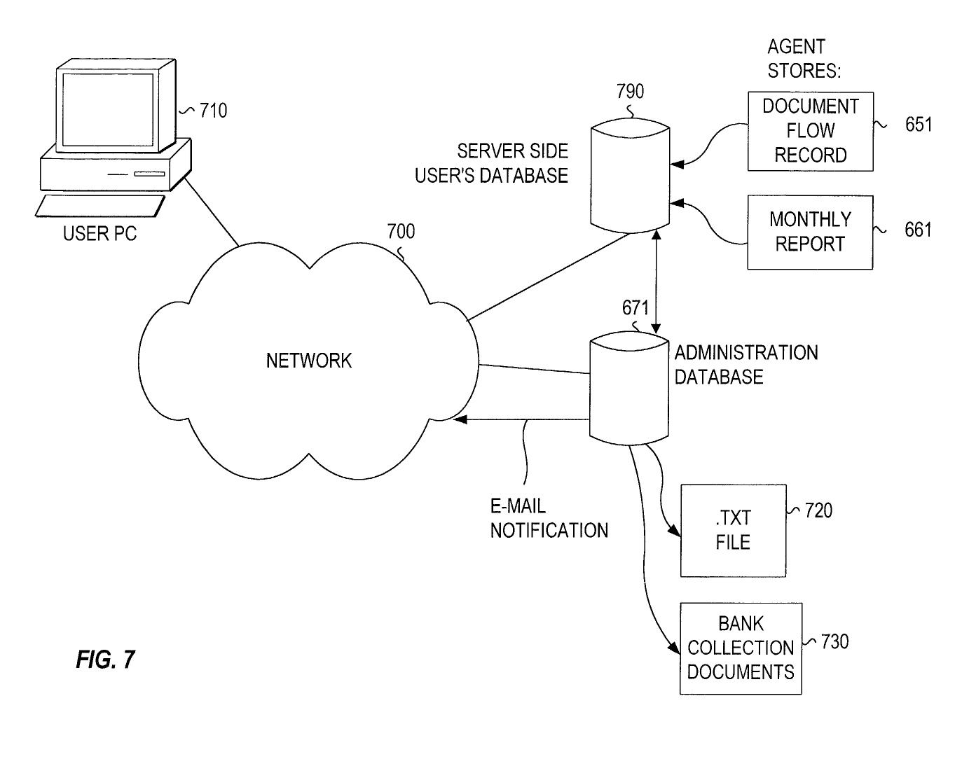

FIG. 7 illustrates an architecture for implementation of the E-commerce application service provider micro-billing method and system. In this embodiment, the user's document flow records (651) and periodic reports (661) are collected and stored on the server side user's database (790). The administrative database (671), also located on the server, can retrieve information (i.e., an extract) from the periodic reports (661) on the server side user's database (790). In one embodiment, the price for each defined transaction (i.e., billable E-commerce service) is registered in the administrative database (671). These prices and the information from the periodic report (661) are combined with information from a system calendar and a memory management utility to create a summary report (not shown) (i.e., a user account extract) for each user. Following creation of a summary report, the user, whose system usage is summarized, is notified of the summary report via an E-mail message. The E-mail message preferably contains a link to the user's summary report, which is stored on the server side of the system. When the link is selected, summary reports are listed in chronological sequence, allowing the user to query through historical summary reports as well as the current summary report. Access to the summary reports can be restricted to the user in the summary report to protect the user's financial information.

A summary report is preferably prepared on a monthly basis, including a summary of the due values for remitted documents and/or memory usage. A .TXT file (720) containing all data from a user's summary report is created by the system. In one embodiment, this .TXT file (720) is exported to existing legacy systems, such as accounts receivable, accounts payable, accounting, etc. A program (application code) will issue collection documents using the .TXT file (720) as its source. In one embodiment, the collection document can be issued to the user by automatically attaching it to bank collection documents (730) issued to the user (as a result of E-commerce transactions) via NOTES. Alternatively, the collection document could be transmitted to the user using another means, such as by mail. In yet another alternative, the collection document can be forwarded as a file to a third party, such as a bank or telecommunications provider for incorporation into the third party billing system (i.e., E-commerce usage charges could be added to a user's phone bill).

FIG. 8A is an exemplary document flow record (illustrated in FIG. 7 as (651). The document flow record can be displayed electronically, such as on a computer monitor. It can also be retrieved electronically or printed. Preferably, each document flow record comprises the type or model of transaction document transmitted, the date and time that the transaction document was sent, and the addressee of the transaction document. The defined set of transactional documents for which a document flow record is created and stored (i.e., remitted documents) can include, but is not limited to, requests for quotes, requests for bids, offers of sale, quotations, sales contracts, purchasing contracts, and purchase orders.

In a preferred embodiment, an agent installed at the server side runs periodically to capture the information for the document flow records from the server side users database 790. The agent then stores the information in a database. This agent is preferably run daily during a low-usage period such as overnight. Optionally, the agent can also record the updated size of the server side user's database 790 in kilobytes. This information (i.e., data) is progressively stored on a formatted periodic report.

FIG. 8B illustrates an exemplary periodic report (shown in FIG. 7 as (661). The periodic report is a database created by progressively storing the information from the document flow records each time the agent is run onto a previously formatted periodic report. The periodic report preferably comprises an historic record of remitted documents by document type, providing dates and times of document exposition and the name of the addressees for each remitted document for a defined period of time, preferably a month. Preferably, the periodic report further comprises the month and year of the set of records contained therein, the name of the user's base where the billing is being made, the present size of the server side user's database, the average size of the server side user's database, and total number of remitted documents by document type for the period of the report.

The document flow records and the periodic reports are stored in the server side user's database. Information from these reports can be retrieved by the user through its site's administration area. For example, a list of all documents sent by the user including date and addressee could be retrieved. In addition, the amount of memory used by the database each day and the current month's average memory occupied by the user could be retrieved. An historical view containing the previous month's information could also be retrieved.

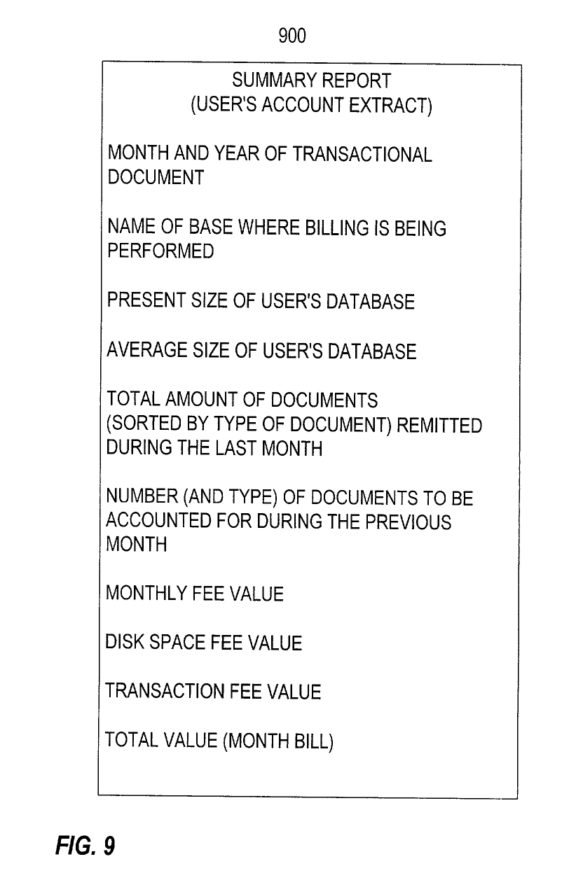

Referring to FIG. 9, a billing agent (i.e., software code sequence) runs at the beginning of each billing cycle to collect and summarize the information from the previous billing cycle. This agent then issues a summary report (900) (i.e., a user extract) summarizing the user's usage and corresponding fees for the billing cycle. While the billing period can be any length of time, it is preferably one month. The billing agent resides on the server side of the system, extracting usage information from the periodic report (661) or the document flow records (651) and extracting pricing information from the administrative database (671) on the server side of the system.

The summary report (900) preferably comprises an identification of the billing cycle (i.e., the month and year of the transactional documents summarized for a monthly billing cycle), the name of the base where the billing is being performed, the present size of the server side user's database, the average size of the server side user's database during the specific billing cycle, the total quantity of remitted documents sent during the specific billing cycle sorted by document type, the quantity and type of transactional documents to be accounted for during the specific billing cycle (i.e., free promotional transactions or monthly transactions included in a base fee), the transactional document fee value for the specific billing cycle (i.e., the total quantity of transactional documents sent during the billing cycle minus the quantity transactional documents to be accounted for times the per document fee for each type of transactional document), the memory usage value (i.e., the charge based on the amount of memory usage of the user if it exceeds a previously defined base size), billing period base fee, and a total fee value (i.e., the sum of the transactional document fee value, the memory usage value, and the billing period base fee).

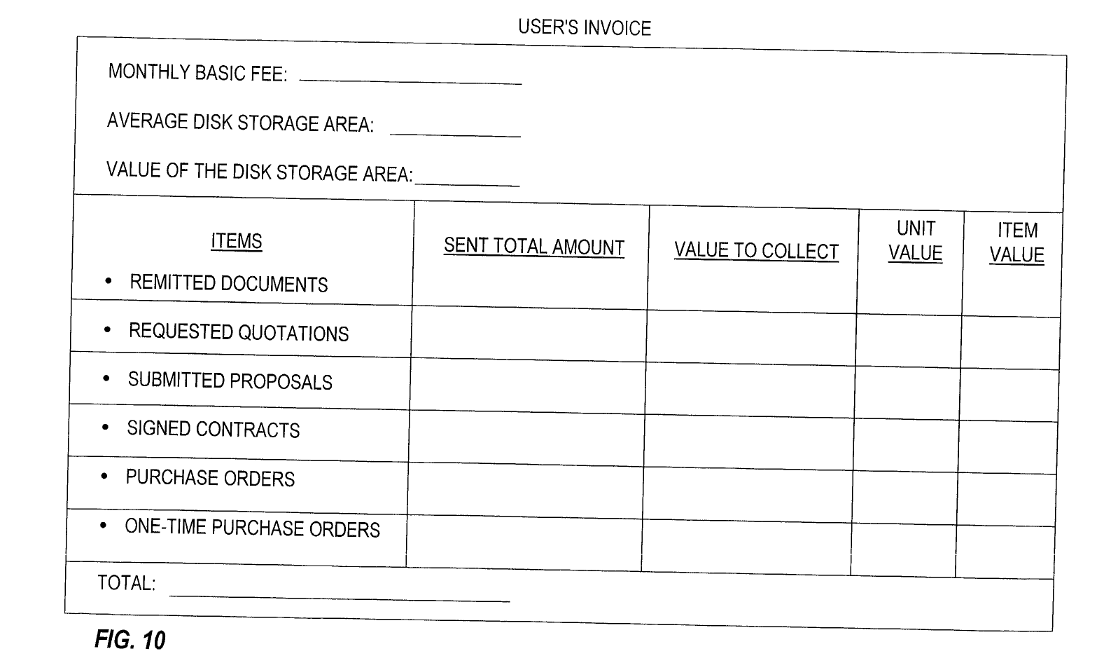

The summary report (900) is then stored on the server side user's database for possible future queries. A copy of the summary report (900) may also be stored on the administration database for statistical and analysis procedures. A .TXT file containing all of the data from each user's summary report (900) is then created by an agent on the server side of the system and made available for export. In one embodiment, the .TXT file can be exported to existing legacy systems controlled by the system administrator (i.e., accounts receivable, accounts payable, accounting, etc.). In an alternative embodiment, the .TXT file can be exported to a program which issues bank collection documents (as a result of E-commerce transactions) to users of the system. This program creates a NOTES document for each user containing the list of collection documents issued to the user. The .TXT file is automatically attached to the NOTES document and made available for download by the user. A sample invoice which would be downloaded by the user is shown in FIG. 10.

In another alterative embodiment, the .TXT file can be exported to a third party, such as a bank or a telecommunications provider who is authorized by the system owner to collect charges incurred by the system users The fees for E-commerce transactions, memory usage, and basic service can then be incorporated into the third party's bill to the particular user. For example, the fees for E-commerce activity could be incorporated into the user's telephone bill, and the telephone company could receive a percentage of the fees collected.

Although this invention has been illustrated by reference to specific embodiments, it will be apparent to those of ordinary skill in the art that various changes and modifications may be made which clearly fall within the scope of the invention. The invention is intended to be protected broadly within the spirit and scope of the appended claims.

What is claimed is:

1. A method for micro-payments in an E-commerce system, the method comprising:
creating a record of usage of the E-commerce system for each system user based on transactional documents transmitted in the E-commerce system;
storing the record of usage on a computer readable medium;
retrieving the record of usage in a periodic manner;
electronically creating an invoice based on the record of usage, wherein the fee established in the invoice is dependant upon system usage by each system user; and
invoicing the system users.

2. The method of claim 1, wherein the invoicing is performed via electronic mail.

3. The method of claim 1, wherein the invoicing is performed by a third party by incorporating fees for usage of an E-commerce system into the third party's billing.

4. The method of claim 3, wherein the third party is a telecommunication service provider.

5. The method of claim 3, wherein the third party is a banking institution.

6. The method of claim 1, wherein the record of usage comprises the type of transaction document, the date and time of transmission of the transactional document, and the addressee of the transactional document for each transactional document.

7. The method of claim 6, wherein the record of usage further comprises the amount of memory consumed by each server side user's database.

8. The method of claim 1, wherein the record of usage is stored in a database on one or more servers in the Internet.

9. The method of claim 1, wherein the record of usage is retrieved by a software agent loaded on the server side of the E-commerce system.

10. The method of claim 1, wherein the record of usage comprises a record of requests for quotation, submitted quotations, submitted proposals, signed contracts for sale or purchase, purchase orders under a contract, and one-time purchase orders.

11. A method for billing users of an E-commerce system based upon each user's usage of the system, the method comprising:
creating a record of usage of the E-commerce system by each system user based on transactional documents transmitted in the E-commerce system on the server side of an E-commerce system;
compiling the record of usage in a database;
extracting usage information from the database in a periodic manner;
combining the usage information with pricing information and transactional documents, which have been accounted for to determine usage fees for each user on the server side of an E-commerce system;
electronically creating an invoice wherein the fee established in the invoice is dependent upon system usage by each system user; and
invoicing the system users.

12. The method of claim 11, wherein the invoicing is performed via electronic mail.

13. The method of claim 11, wherein the invoicing is performed by a third party by incorporating fees for usage of an E-commerce system into the third party's billing.

14. The method of claim 13, wherein the third party is a telecommunication service provider.

15. The method of claim 13, wherein the third party is a banking institution.

16. The method of claim 11, wherein the database comprises the time period of the set of records contained therein, the name of the user's base where the billing is being made, the present size of the server side user's database, the average size of the server side user's database, and total number of remitted documents by document type for the period of the records.

17. The method of claim 11, wherein the record of usage comprises a record of requests for quotation, submitted quotations, submitted proposals, signed contracts for sale or purchase, purchase orders under a contract, and one-time purchase orders.

18. A machine-readable medium having coded thereon program code, wherein the program code is executed by one or more machines over a machine network, the machines implementing a method for performing e-commerce transactions, comprising the steps of:
creating a record of usage of the E-commerce system for each system user based on transactional documents transmitted in the E-commerce system;
storing the record of usage on a computer readable medium;
retrieving the record of usage in a periodic manner;
electronically creating an invoice based on the record of usage, wherein the fee established in the invoice is dependant upon system usage by each system user; and invoicing the system users.
